(19) United States
(12) Patent Application Publication
(10) Pub. No.: US 2015/0107705 A1
(43) Pub. Date: Apr. 23, 2015

(54) Poppet Valve Assembly With In-Line Sight Glass

(71) Applicant: Dixon Valve and Coupling Company, Chestertown, MD (US)

(72) Inventor: Richard L. Fahl, Fairfield, OH (US)

(73) Assignee: Dixon Valve and Coupling Company, Chestertown, MD (US)

(21) Appl. No.: 14/058,622

(22) Filed: Oct. 21, 2013

(51) Int. Cl. F16K 37/00

(52) U.S. Cl. CPC F16K 37/0058
USPC 137/559

(57) ABSTRACT

A poppet valve assembly is provided for use on a fuel tanker truck which enables the truck's driver to determine whether fuel is present in the valve assembly. The valve assembly has a housing which has a sight glass secured therein. The sight glass is visible through cut-outs in the housing. If the driver observes liquid in the valve assembly, the driver may drain the valve assembly to avoid spilling the liquid prior to opening the poppet valve assembly. When the poppet valve assembly is opened, vapor flows through a flow channel in the poppet valve assembly.

### FIELD OF THE INVENTION

This invention relates generally to poppet valve assemblies for controlling flow therethrough of vapors, such as gasoline vapors, from a gasoline tank truck to a loading rack facility or from an underground storage tank at a filling station into a tank truck.

### BACKGROUND OF THE INVENTION

In order to fill one or more underground storage tanks at a gasoline service station, a cargo tank truck typically pulls into the service station and unloads the fuel from the truck into the underground storage tank or tanks. Such a cargo tank truck commonly has multiple fuel storage compartments, each compartment having a cover and a pipe located below the tank to which is connected a valve assembly. The valve assembly is commonly a poppet valve assembly which is opened and closed by the truck's driver via a handle extending upwardly from the valve assembly, such as the poppet valve assembly disclosed in U.S. Pat. No. 7,896,027. In order to unload fuel from one of the truck's fuel storage compartments into the underground storage tank, the truck driver or operator connects two hoses from the truck to elbows on the underground storage tank. One of the hoses is a vapor recovery hose which returns vapors to the truck from the underground storage tank. The other hose is connected at one end to one of the valve assemblies on the truck via an adaptor and at the other end to the underground storage tank. In order to cause fuel to flow through this hose to the underground storage tank, the truck driver simply opens the valve assembly.

In order to prevent the vapors in the underground storage tank from being pushed into the environment as they are displaced by the incoming fuel, a vapor return line is connected from the underground storage tank back to the cargo tank truck. This vapor return line is connected to the cargo tank truck typically at a poppet valve assembly. The poppet valve assembly on the cargo tank truck prevents gasoline vapors from escaping from the cargo tank truck until the vapor return line from the underground storage tank is connected. The vapor return line from the underground storage tank typically has a fitting with a probe on the end that pushes the poppet open in the poppet valve assembly.

It is common that the poppet valve assembly on the cargo tank truck contains some liquid from condensation or other means prior to the vapor return line from the underground storage tank being connected to the poppet valve assembly on the cargo tank truck. Since the poppet in the poppet valve assembly is opened by a probe in the fitting at the end of the vapor return line, there is a point at which the poppet is opened before the seal between the two fittings is engaged. As this happens, any liquid present in the poppet valve assembly will be released and may spill on the driver. Consequently, it is advantageous for the driver to know whether fluid is present in the poppet valve assembly.

One such method, shown in FIGS. 1 and 1A, involves securing a sight glass between the mounting flange of a discharge pipe of the truck and a poppet valve assembly. One disadvantage with using this type of in-line sight glass is that the sight glass is highly stressed by the bolts that attach it to the mounting flange of a discharge pipe of a truck. The result is that the sight glass has a short lifespan and must be replaced often. Due to the large size of such a sight glass, repair is costly and may remove the tanker truck from operation for a lengthy period of time.

Another method, shown in FIGS. 2 and 2A, involves securing a sight glass assembly between the mounting flange of a discharge pipe of the truck and a poppet valve assembly. This sight glass assembly uses a smaller sight glass than the one described in the above paragraph. This sight glass is contained within a metal brace. Therefore, the metal brace, as opposed to the sight glass, bears the stresses imposed by the mounting bolts. One disadvantage with using this type of in-line sight glass is that, from a distance, it may be difficult to view the interior of the poppet valve assembly. Therefore, it will be difficult to determine if fluid is present. Another disadvantage with using this type of in-line sight glass assembly is the high cost of the sight glass assembly due to its multiple components and required assembly.

Each of these methods requires securing an element or elements between the mounting flange of the discharge pipe on the truck and the mounting flange of a poppet valve assembly, thereby increasing the chance of leaks or spills while increasing the cost of assembly, i.e., more labor. Therefore, it has been one objective of the present invention to provide a poppet valve assembly having an in-line sight glass incorporated into the poppet valve assembly which enables one to determine whether fluid is present in the poppet valve assembly from a distance and, if so, the driver can take appropriate actions so as not to get splashed with the liquid while making a connection to the poppet valve assembly.

### SUMMARY OF THE INVENTION

The invention which accomplishes these and other objectives comprises a poppet valve assembly for use on a fuel tanker truck for loading vapors onto the truck, most commonly from an underground storage tank at a service station or unloading vapors from the truck to a collection facility.

The poppet valve assembly comprises a housing having a flow passage therethrough. The flow passage has a central axis. In one embodiment, the housing is a unitary housing, including a poppet support or finger extending inwardly from a housing wall.

The poppet valve assembly further comprises a poppet structure for controlling vapor flow through the flow passage. The poppet structure is movable between open and closed positions so that when an operator joins a coupler to the poppet valve assembly, the poppet structure moves axially, thereby opening the valve and enabling vapors to flow through the flow passage.

An in-line sight glass is mounted inside the housing. The sight glass, in one embodiment, comprises one piece of see-through material, such as acrylic or other plastic. The sight glass is preferably made of one piece of plastic, but may be made of multiple pieces. The sight glass is preferably made of acrylic, but may be made of any see-through material, such as glass. The sight glass is generally cylindrical and has an axis which is generally coaxial with the central axis of the flow passage. The sight glass has an opening which is in fluid communication with the flow passage. The sight glass is held inside the housing with a retainer and is visible from a distance due to cut-outs in the housing. The size and shape of the cut-outs in the housing enable a truck operator to determine from a distance: 1) whether fluid is present in the poppet valve assembly; and, 2) the color of the fluid in the poppet valve assembly, i.e., the type of fluid in the poppet valve assembly. Being able to quickly and easily determine these items may prevent the operator from accidently opening the poppet valve assembly and spilling fluid.

The size and shape/configuration of the in-line sight glass are such that it may be made at a relatively low cost. The poppet valve assembly enables a truck operator to determine whether fluid is present in the poppet valve assembly easily from a distance before closing the clamps on the coupler to open the valve. Thus, the poppet valve assembly of this invention helps prevent an operator from accidently discharging fluid onto the ground or himself/herself before opening the poppet valve assembly.

These and other objects and advantages of this invention will be more readily apparent from the following drawings.

### BRIEF DESCRIPTION OF THE DRAWINGS

FIG. 1 is a partially disassembled view of a prior art in-line sight glass located between an outer flange of a discharge pipe of a tanker truck and a prior art poppet valve assembly;

FIG. 1A is a side elevational view of the prior art in-line sight glass of FIG. 1 secured between the outer flange of the discharge pipe of a tanker truck and a prior art poppet valve assembly;

FIG. 2 is a partially disassembled view of a prior art in-line sight glass assembly located between an outer flange of a discharge pipe of a tanker truck and a prior art poppet valve assembly;

FIG. 2A is a side elevational view of the prior art in-line sight glass assembly of FIG. 2 secured between the outer flange of the discharge pipe of a tanker truck and a prior art poppet valve assembly;

FIG. 3 is a perspective view of a fuel tanker truck unloading fuel into an underground storage tank at a service station;

FIG. 4A is a front perspective view of the poppet valve assembly of the present invention;

FIG. 4B is a rear perspective view of the poppet valve assembly of the present invention;

FIG. 5 is a front perspective view of the poppet valve assembly of the present invention mounted on a vapor recovery pipe of a fuel tanker truck to which a coupler and hose are being connected;

FIG. 6A is a cross-sectional view of the poppet valve assembly of FIG. 4A showing the poppet structure in a closed position so no vapors pass through the poppet valve assembly;

FIG. 6B is another cross-sectional view of the poppet valve assembly of FIG. 6A showing the probe of the coupler contacting the poppet structure, but not yet opening the poppet valve assembly;

FIG. 6C is another cross-sectional view of the poppet valve assembly of FIG. 6A showing the poppet structure in an open position, vapors passing through the poppet valve assembly from an underground storage tank into the truck;

FIG. 7 is a partially disassembled view of the poppet valve assembly of FIG. 4A; and

FIG. 8 is a perspective view of the housing of the poppet valve assembly of FIG. 4A.

### DETAILED DESCRIPTION OF THE INVENTION

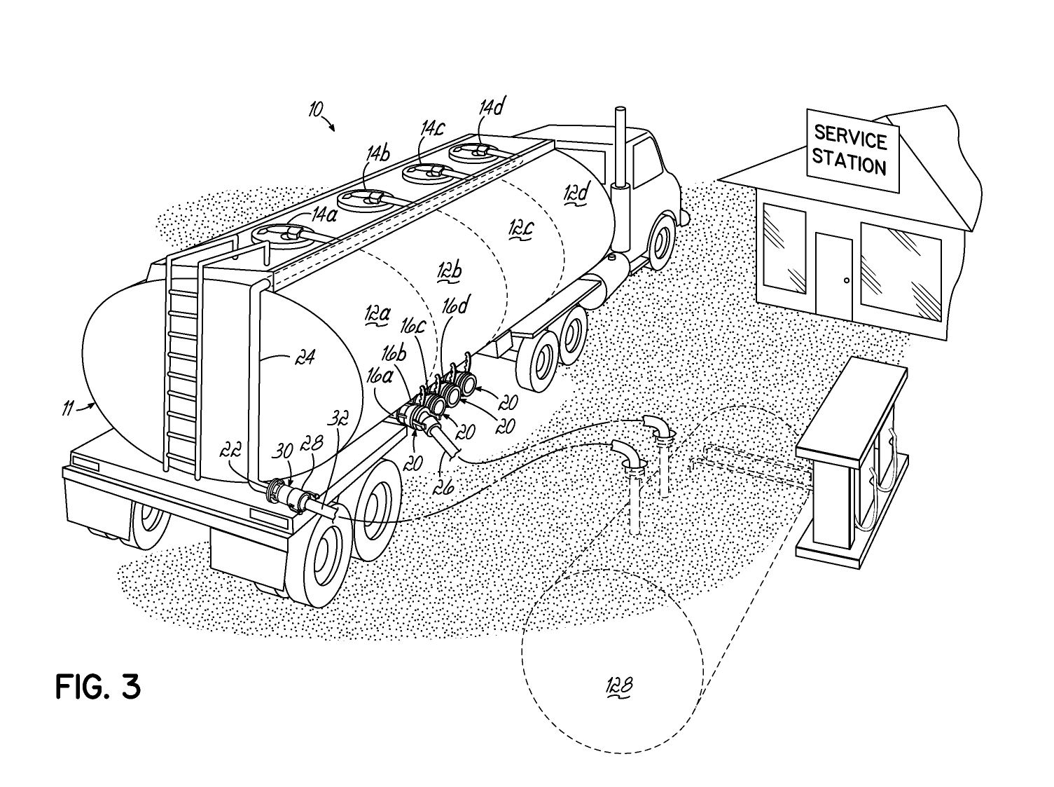

Referring to the figures, and particularly FIG. 3, there is illustrated a fuel tanker truck 10 having a tank 11 with four compartments 12a, 12b, 12c, and 12d having respective covers 14a, 14b, 14c, and 14d. Although the compartments are illustrated by dashed lines, these dashed lines are for illustration purposes only. The truck may have any number of compartments in any location. Below the tank 11 are a plurality of pipes 16a, 16b, 16c, and 16d in fluid communication with the compartments 12a, 12b, 12c, and 12d, respectively. Each of the pipes 16a, 16b, 16c, and 16d has a poppet valve assembly 20 secured to a mounting flange at the end thereof, like the one disclosed in U.S. Pat. No. 7,896,027 to control the flow of fuel.

A different poppet valve assembly 30, the subject of the present invention, is secured to a mounting flange 22 located at the lower end of a vapor recovery pipe 24 to control the flow of fuel vapors or gases. As shown in FIG. 3, the vapor recovery pipe 24 extends to all the truck compartments. When the truck's fuel is unloaded from the truck's tank 11 into the underground storage tank 128, vapors or gases in the underground storage tank 128 must exit the underground storage tank 128. Such gasoline vapors pass through a vapor recovery hose 32, through the poppet valve assembly 30 of the present invention, through the vapor recovery line 24 of the truck 10 and into the truck's tank compartments. The truck 10 filled with gases or vapors rather than fluid then is driven to a loading rack facility where the truck's tank 11 is filled with liquid fuel. When the truck's tank 11 is filled with liquid, vapors inside the truck are unloaded at a loading rack facility. The vapors inside the truck then pass in the opposite direction out of the truck's tank 11, through the poppet valve assembly 30 and into a collection facility for proper disposal.

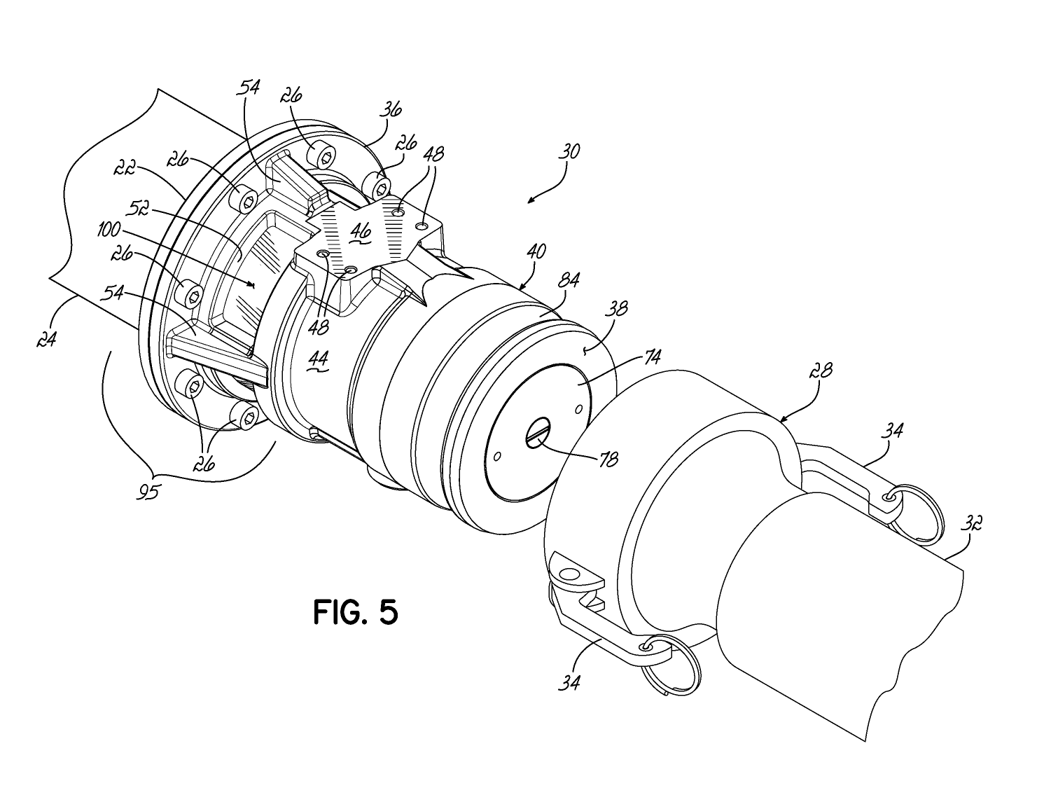

As illustrated in FIG. 5, poppet valve assembly 30 and, more particularly, a rear mounting flange 36 of the poppet valve assembly 30 is secured to the mounting flange 22 of the vapor recovery pipe 24 with nuts (not shown) and bolts 26 in a manner known in the art. The poppet valve assembly 30 is the subject of the present invention and is described in more detail below.

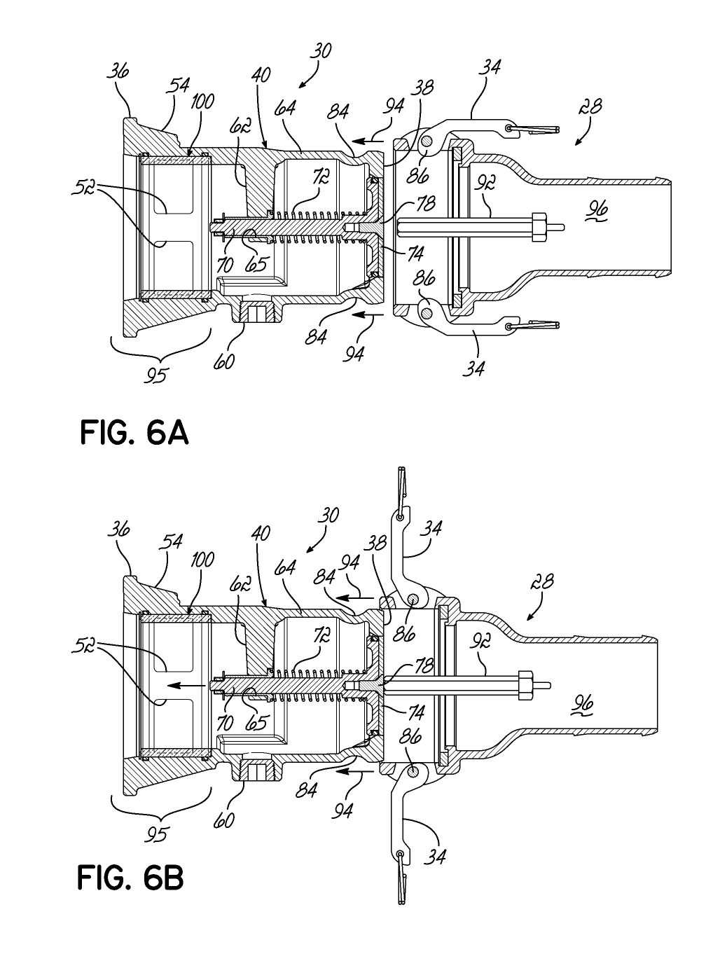

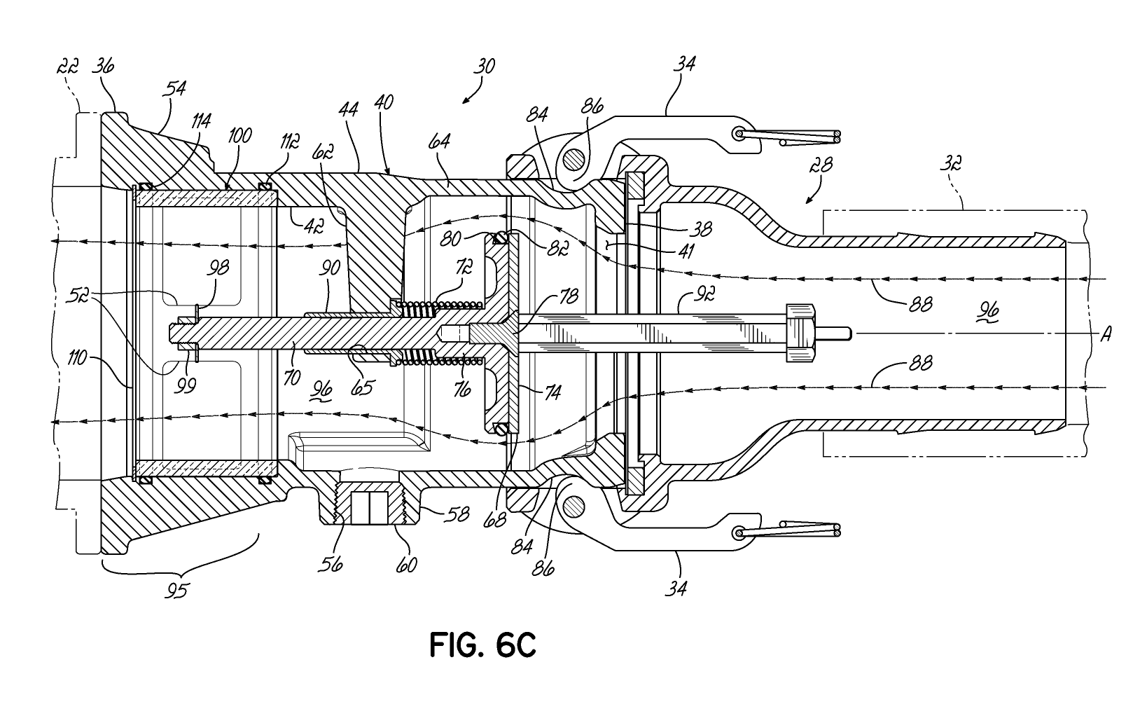

As shown in FIGS. 3 and 5, a coupler 28 is secured to the end of a vapor recovery hose 32 which extends to underground storage tank 128. The coupler 28 has a pair of cam arms 34 which function to help secure the coupler 28 to the poppet valve assembly 30 and maintain the coupler 28 and poppet valve assembly 30 together. The vapor recovery line or pipe 24 forms part of the truck 10 and is secured to poppet valve assembly 30 at its end. The poppet valve assembly 30 may be connected to/disconnected from the vapor recovery hose 24 using coupler 28. The vapor recovery hose 32 extends to the underground storage tank 128, as is conventional in the art. As best shown in FIGS. 6A-6C, coupler 28 has a probe 92 fixed therein which functions to open the poppet valve assembly 30 upon the coupler 28 being moved, as described below. Simple movement of the coupler 28 and a closing of the cam arms 34 opens the poppet valve assembly 30 allowing vapors to pass through the valve assembly without the need for a handle to open/close the poppet valve assembly 30.

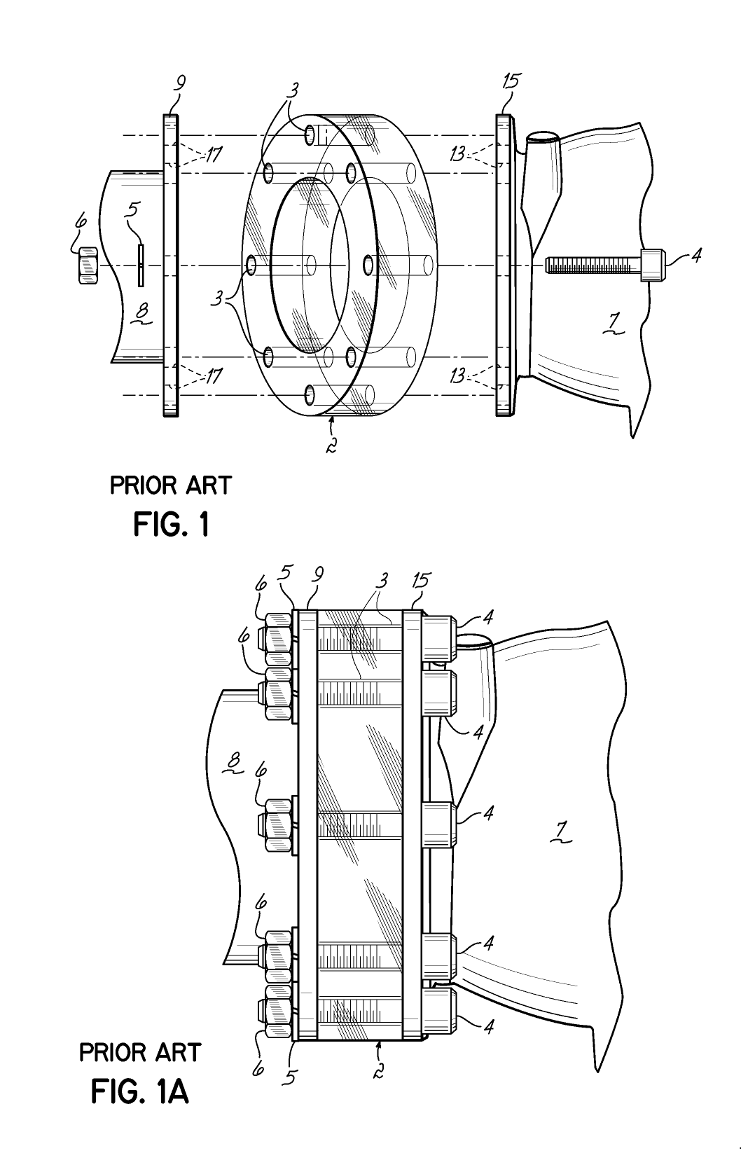

FIG. 1 illustrates a prior art in-line sight glass 2 having a plurality of holes 3 therethrough adapted to receive threaded bolts 4. As is conventional, a washer 5 and nut 6 are used to complete the connection of a prior art poppet valve assembly 7 to a discharge pipe 8 having a mounting flange 9. Many known prior art poppet valve assemblies have mounting flanges for this purpose, such as the poppet valve assembly disclosed in U.S. Pat. No. 4,813,449. As shown in FIGS. 1 and 1A, when assembled, the bolts 4 pass through the holes 3 of the in-line sight glass 2, holes 13 in a rear mounting flange 15 of prior art poppet valve assembly 7 and holes 17 through the mounting flange 9 of the discharge pipe 8. As shown in FIG. 1A, bolts 4 are tightened with nuts 6, thereby squeezing the in-line sight glass 2 between the rear mounting flange 15 of prior art poppet valve assembly 7 and the mounting flange 9 of the discharge pipe 8. Stress caused by the connection between the prior art poppet valve assembly 7 and discharge pipe 8 give the in-line sight glass 2 a relatively short useful life and increase the frequency of repair/replacement of the in-line sight glass 2.

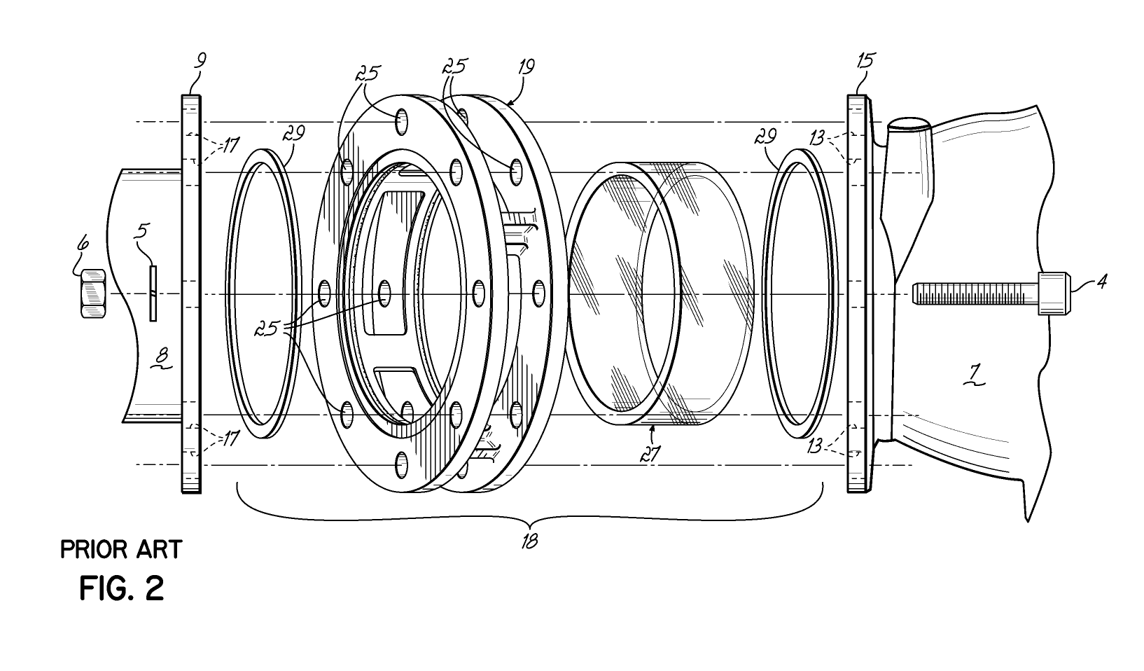

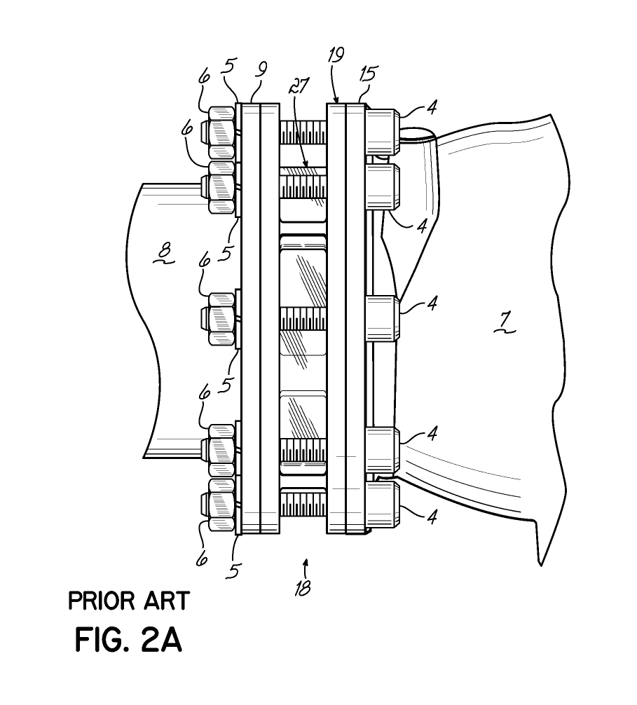

FIGS. 2 and 2A illustrate a prior art in-line sight glass assembly 18 comprising a metal brace 19 having a plurality of holes 25 therethrough, a plurality of threaded bolts 4, a see-through sight glass 27 adapted to fit inside metal brace 19, a pair of O-rings 29, washers 5 and nuts 6. The prior art in-line sight glass assembly 18 is used to connect a prior art poppet valve assembly 7 to a discharge pipe 8 having a mounting flange 9. As shown in FIGS. 2 and 2A, when assembled, the bolts 4 pass through the holes 25 of the metal brace 19, holes 13 in a rear mounting flange 15 of prior art poppet valve assembly 7, and holes 17 through the mounting flange 9 of the discharge pipe 8. As shown in FIG. 2A, bolts 4 are tightened with nuts 6, thereby squeezing the prior art in-line sight glass assembly 18 between the rear mounting flange 15 of prior art poppet valve assembly 7 and the mounting flange 9 of the discharge pipe 8. Although prior art in-line sight glass assembly 18 may reduce the frequency of repair/replacement of the in-line sight glass 27 as compared to the sight glass 2 shown in FIGS. 1 and 1A, prior art in-line sight glass assembly 18 is relatively expensive to manufacture, and the configuration of the metal brace 19 may not allow sufficient visibility of the fluid inside the sight glass 27.

Use of either prior art sight glass 2 and prior art in-line sight glass assembly 18 requires an additional piece or pieces to be secured between a rear mounting flange 15 of a prior art poppet valve assembly 7 and a mounting flange 9 of a discharge pipe 8. As shown in FIG. 5, the poppet valve assembly 30 of the present invention allows a straight connection between a rear mounting flange 22 of a vapor recovery pipe 24 on a truck 10 and a rear mounting flange 36 of poppet valve assembly 30 with no intermediate member therebetween. Advantages of poppet valve assembly 30 having an in-line sight glass are: 1) visibility of the fluid inside the poppet valve assembly 30 is greater than heretofore; 2) the amount of plastic used for the sight glass is reduced, reducing the cost of the poppet valve assembly; and, 3) the in-line sight glass of the poppet valve assembly has a longer useful life than prior art sight glasses because the in-line sight glass is not subject to compression stresses.

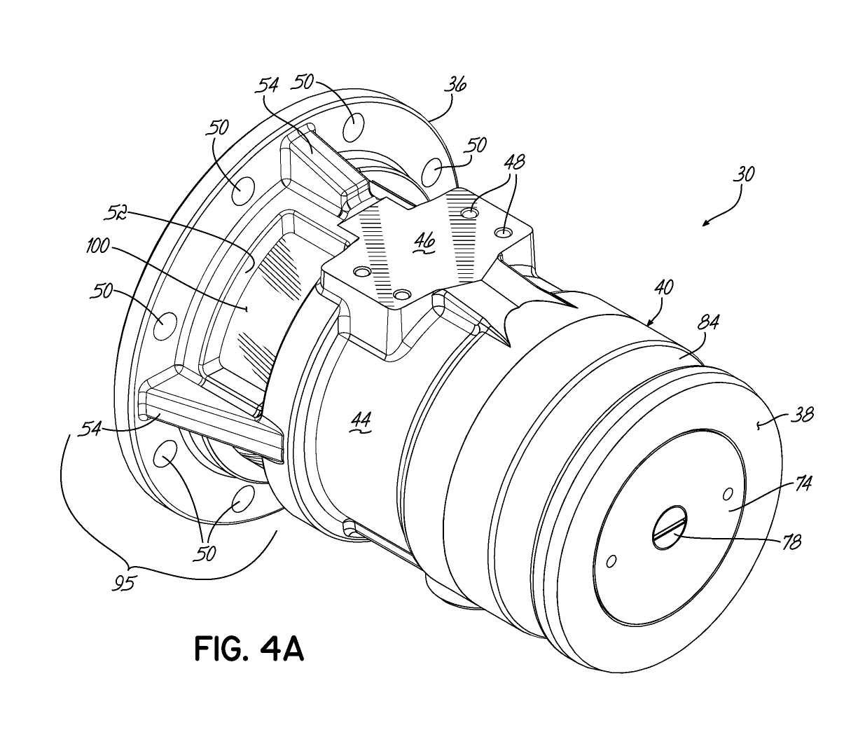

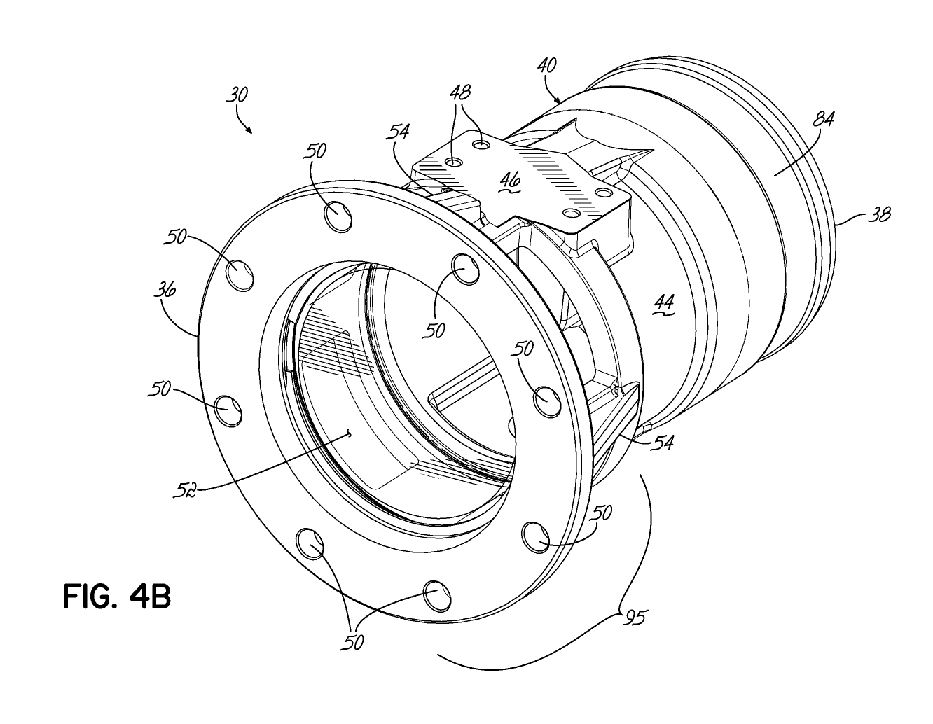

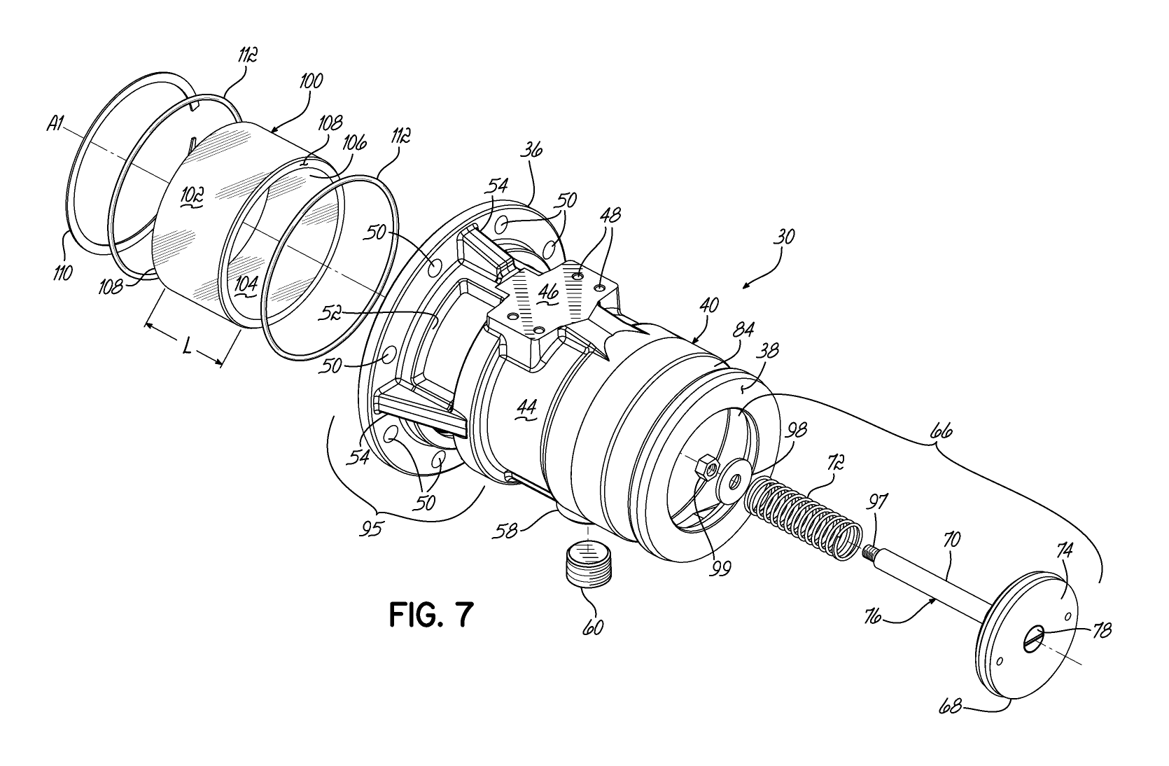

The poppet valve assembly 30 of the present invention is illustrated in detail in FIGS. 4A-4B. Referring to FIGS. 4A, 4B and 7, the poppet valve assembly 30 comprises a unitary housing 40 having an inside surface 42 and an outside surface 44. The housing 40 is typically made via casting. As best shown in FIGS. 4A and 5, the housing 40 has a front flange 38 and a rear mounting flange 36. Immediately to the rear of the front flange 38 of housing 40 is an annular groove 84 sized and adapted to receive cams 86 of cam arms 34 to secure the coupler 28 to the poppet valve assembly 30, such that the poppet structure 66 described herein may be maintained in an open position, allowing vapors to flow through the poppet valve assembly 30 in either direction.

As shown in FIGS. 5 and 7, the housing 40 has a generally planar mounting surface 46 having a plurality of threaded openings 48 therein adapted to receive fasteners (not shown) for securing an optional air interlock valve (not shown) to the poppet valve assembly 30. The function of the optional air interlock valve is to lock the truck's brakes.

As best illustrated in FIGS. 4A and 4B, the rear mounting flange 36 of housing 40 has a plurality of spaced openings 50 therethrough to secure the poppet valve assembly 30 to the mounting flange 22 located at the lower end of vapor recovery pipe 24 of the truck 10 with fasteners 26. See FIG. 5. As best illustrated in FIGS. 4A and 4B, a rear portion 95 of the housing 40 has a plurality of cut-outs 52 between spaced vanes 54.

As shown in FIGS. 6C, 7 and 8, the housing 40 also has a threaded opening 56 defined inside a circular flange 58 located opposite the generally planar mounting surface 46. As shown in FIG. 6C, threaded opening 56 is adapted to receive and retain a threaded plug 60. When the driver wants to empty fluid from inside the poppet valve assembly 30, the driver may remove the plug 60 from the opening 56 and drain the unwanted fluid.

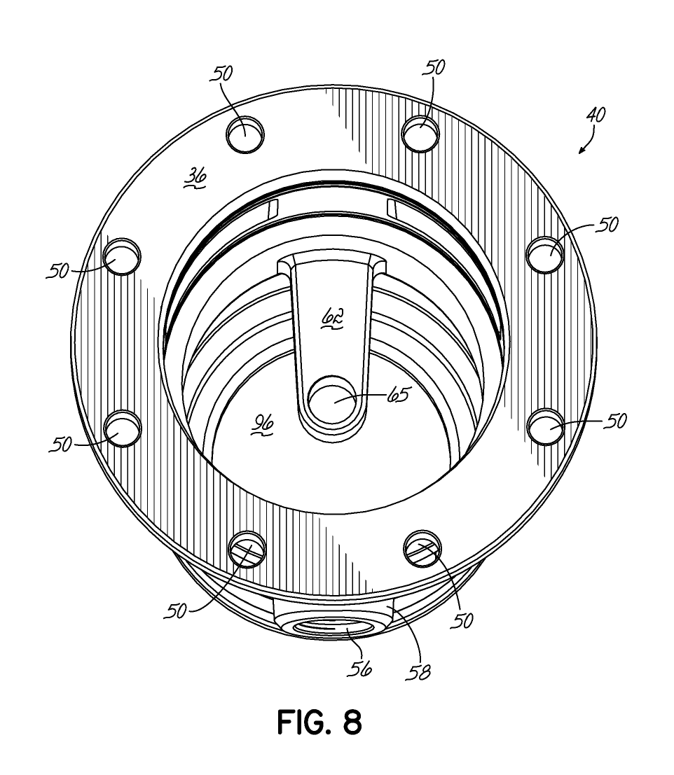

As best shown in FIGS. 6C and 8, a poppet support or finger 62 is integral with the housing 40. More particularly, the finger 62 extends radially inwardly from a housing wall 64 and is cast with the housing. As shown in FIG. 8, the poppet support or finger 62 has an opening 65 at the distal end thereof, which functions to support a portion (the stem 70) of a poppet structure 66. Alternatively, the poppet support may be a separate piece not integral with the housing such as a removable poppet support. One example of such a removable poppet support is a hub having multiple fingers or spokes extending outwardly from the hub. Although the opening 65 is illustrated as being circular, it may be any desired shape or size. As shown in FIG. 6C, a flow passage 96 is defined between the inner surface 42 of the housing 40 and the poppet structure 66. Vapors flow through the flow passage 96 around the finger 62. See arrows 88 of FIG. 6C. FIG. 6C shows the vapors flowing from the underground storage tank 18, through the vapor recovery hose 32 and coupler 28 before passing through the poppet valve assembly 30 (from front to rear) and then into the vapor recovery line 24 of truck 10 during the process of unloading liquid from the tanker truck 10 into the underground storage tank 128. However, during the process of filling the interior of tank 11 of truck 10 with fluid, the vapors may pass the other direction out the vapor recovery line 24, through the poppet valve assembly 30 (from rear to front) and into a collection facility provided a coupler at the end of a hose at the collection facility is able to maintain the poppet valve assembly 30 in an open position.

As best illustrated in FIGS. 6C and 7, a poppet structure 66 having a generally disk-shaped front portion 68, and a rear portion or stem 70, is biased forwardly in a forward or closed position by a spring 72, as is conventional in poppet valve assemblies. As best illustrated in FIG. 7, the rear portion 70 of the poppet structure 66 ends in a threaded portion 97. A washer 98 and threaded nut 99 engaged with the threaded portion 97 are illustrated assembled in FIG. 6C. As best illustrated in FIG. 6C, the front portion 68 of poppet structure 66 comprises a cover 74 attached to a body 76 of the poppet structure 66 with a fastener 78. The body 74 of the poppet structure 66 comprises the rear portion or stem 70 of the poppet structure 66 along with the front portion 68 other than the cover 72. Between the cover 72 and the body 74 of the poppet structure 66 is a groove 80 in which resides an O-ring 82, as shown in FIG. 6C. In the event the O-ring 82 needs to be replaced, an operator may remove the fastener 78, then remove the cover 74, allowing the O-ring 82 to be removed and replaced.

The poppet structure 66 is movable via movement of the coupler 28 at the end of the hose 32 between a first or forward closed position and a second or rear open position (the first or closed position being shown in FIG. 6A and the second or open position being shown in FIG. 6C). When the poppet structure 66 is in its closed forward position shown in FIG. 6A, the O-ring 82 contacts the conical inner surface 41 of the front flange 38 of housing 40, thereby preventing vapors from flowing through the flow passage 96 of poppet valve assembly 30. See FIG. 6C. As shown in FIG. 6C, between the poppet structure 66 and the inner surface 42 of housing 40 is a flow passage 96 having a central axis A. When the poppet valve assembly 30 of the present invention is opened, i.e., the poppet structure 66 moved rearwardly to its open rear position, vapors flow through the flow passage 96 in the direction of arrows 88 from the front to the rear of the poppet valve assembly 30 (to the left in FIG. 6C).

As best shown in FIG. 6C, rear portion or stem 70 of the poppet structure 66 moves inside a guide or bearing 90 which extends through the opening 65 of the finger 62. This guide or bearing 90 provides a stop against which the spring 72 may push in order to compress when the poppet structure 66 is pushed rearwardly by movement of the coupler 28 causing the probe 92 of the coupler 28 to contact and move rearwardly the front portion 68 of the poppet structure 66 in the direction of arrows 94 shown in FIG. 6B. As shown in FIGS. 6A-6C, in order to move the poppet structure 66 in a rearward direction against the bias of the spring 72 and open the poppet valve assembly 30, the probe 92 and coupler 28 is moved rearwardly by the operator of the truck in the direction of arrows 94. Movement of the coupler 28 in the direction of arrows 94 (rearwardly as shown in FIGS. 6A and 6B) causes the probe 92 to push against the cover 74 of the poppet structure 66 and move the poppet structure 66 rearwardly, from a closed position shown in FIG. 6A to an open position shown in FIG. 6C. After the poppet structure 66 is moved rearwardly a sufficient distance, vapors may flow through the flow passage 96 inside the housing 40, out of the valve assembly 30 into the vapor recovery pipe 24 and ultimately into the truck's compartments.

As best illustrated in FIGS. 5 and 7, a single piece in-line sight glass 100 is secured inside the housing 40 and, more particularly, on the inside of a rear portion 95 of the housing 40. The sight glass 100 is generally cylindrical, has an outer surface 102 which defines its outer diameter, an inner surface 104 which defines an inner diameter or opening 106 of the sight glass 100. As shown in FIG. 7, the sight glass opening 106 has an axis A1, which is generally aligned or coaxial with the axis A of the flow channel 96 (see FIG. 6C) when the poppet valve assembly 30 is assembled. When the poppet structure 66 is moved rearwardly (to the left in FIG. 5) by an operator moving the coupler 28 rearwardly in the direction of arrows 94 (to the left in FIG. 6B), vapors may pass through the opening 106 in sight glass 100 and through the flow channel 96, which is in fluid communication with the sight glass opening 106. As shown in FIG. 7, in-line sight glass 100 has a length L defined by generally parallel side surfaces 108. Although one size sight glass 100 is shown, any other size of sight glass may be used in accordance with the present invention.

The sight glass 100 is preferably made of transparent plastic, such as acrylic which one may see-through, although it may be made of any transparent or see-through material. The sight glass 100 is visible at a distance through cut-outs 52 of the rear portion 95 of the housing 40.

As shown in FIG. 7, the sight glass 100 is held in the rear portion 95 of the housing 40 with a retainer 110. Although retainer 110 is preferably made of metal, it may be made of any suitable material. As shown in FIGS. 6C and 7, a pair of O-rings 112 surrounds sight glass 100. Each O-ring 112 is located in a groove 114 in the rear portion 95 of the housing 40. These O-rings 112 provide a snug fit of the sight glass 100 inside the rear portion 95 of the housing 40.

Although I have described one preferred embodiment of my invention, I do not intend to be limited except by the scope of the following claims.

I claim:

1. A poppet valve assembly for use on a fuel tanker truck for allowing vapors to enter and exit the truck, the assembly comprising:
a housing;
a flow passage in the housing, the flow passage having a central axis;
a poppet structure for controlling vapor flow through the flow passage, the poppet structure having a stem extending through a poppet support; and
a sight glass mounted inside the housing, the sight glass having an opening in fluid communication with the flow passage wherein the opening has an axis aligned with the central axis of the flow passage.

2. The poppet valve assembly of claim 1 wherein the sight glass is held inside the housing with a retainer.

3. The poppet valve assembly of claim 1 wherein the housing has cut-outs for viewing the sight glass.

4. The poppet valve assembly of claim 1 wherein the sight glass has an outer diameter and an inner diameter defined by the opening.

5. The poppet valve assembly of claim 4 further comprising O-rings around the outside diameter of the sight glass.

6. The poppet valve assembly of claim 1 wherein the sight glass is made of plastic.

7. The poppet valve assembly of claim 1 wherein the poppet support comprises a finger extending inwardly from a housing wall.

8. The poppet valve assembly of claim 1 wherein the sight glass is made of see-through material.

9. A poppet valve assembly for use on a fuel tanker truck for allowing vapors to enter and exit the truck, the assembly comprising:
a housing having an annular groove therein;
a flow passage in the housing, the flow passage having a central axis;
a poppet structure for controlling fluid flow through the flow passage;
a sight glass mounted inside the housing wherein the poppet structure moves by a probe inside a fitting at the end of a line from a storage tank contacting the poppet structure when cams of the fitting engage the groove in the housing to open the flow passage.

10. The poppet valve assembly of claim 9 wherein the sight glass has an opening in fluid communication with the flow passage.

11. The poppet valve assembly of claim 9 wherein the sight glass is held inside the housing with a retainer.

12. The poppet valve assembly of claim 9 wherein the housing has cut-outs for viewing the sight glass.

13. The poppet valve assembly of claim 10 wherein the opening has an axis aligned with the central axis of the flow passage.

14. The poppet valve assembly of claim 10 wherein the sight glass has an outer diameter and an inner diameter defined by the opening.

15. The poppet valve assembly of claim 9 wherein the sight glass is made of plastic.

16. The poppet valve assembly of claim 9 wherein the sight glass is made of see-through material.

17. A poppet valve assembly for use on a fuel tanker truck for allowing vapors to enter and exit the truck, the poppet valve assembly comprising:
a housing;
a flow passage in the housing;
a poppet structure for controlling fluid flow through the flow passage, a portion of the poppet structure passing through a poppet support;
a sight glass mounted inside the housing, the sight glass having an opening in fluid communication with the flow passage wherein the flow passage may be opened and closed with the poppet structure.

18. The poppet valve assembly of claim 17 wherein the sight glass is made of plastic.

19. The poppet valve assembly of claim 17 wherein the poppet support comprises a finger extending inwardly from a housing wall.

20. The poppet valve assembly of claim 17 wherein the sight glass is made of see-through material.
